(19) United States
(12) Patent Application Publication
(10) Pub. No.: US 2009/0199480 A1
(43) Pub. Date: Aug. 13, 2009

(54) COVER FOR GUIDE PARTS OF A MOTOR VEHICLE SLIDING DOOR

(75) Inventor: Winfried EHRHARD, Munster (DE)

Correspondence Address: INGRASSIA FISHER & LORENZ, P.C. (GME), 7010 E. COCHISE ROAD, SCOTTSDALE, AZ, 85253, US

(73) Assignee: GM GLOBAL TECHNOLOGY OPERATIONS, INC., Detroit, MI (US)

(21) Appl. No.: 12/366,780

(22) Filed: Feb. 6, 2009

(30) Foreign Application Priority Data
Feb. 8, 2008 (DE) 102008008128.0

(51) Int. Cl. E05D 15/10; E05D 15/06

(52) U.S. Cl. 49/212; 49/413

(57) ABSTRACT

A sliding door of a motor vehicle is provided as well as a cover device for such a sliding door, that includes, but not limited to at least one guide rail assigned to the inner side of a sliding door leaf that engages with a sliding element. The sliding element is connected to the supporting structure of the vehicle by means of a pivotably mounted pivoted lever. The cover device is configured to substantially separate the guide rail with respect to the vehicle interior, at least in the closed position of the door leaf.

### CROSS-REFERENCE TO RELATED APPLICATION

This application claims priority to German Patent Application No. 102008008128.0, filed Feb. 8, 2008, which is incorporated herein by reference in its entirety.

### TECHNICAL FIELD

The present invention relates to a cover device for guide parts of a door leaf of a motor vehicle sliding door as well as a sliding door having a guide rail provided on the inside of its sliding door leaves.

### BACKGROUND

Sliding doors have numerous applications in motor vehicles, in particular in public service vehicles, but increasingly also in large-capacity limousines, which are designed for transporting five or more persons.

Known from DE 43 15 616 A1 is a swing-out sliding door for vehicles, on the inside of a door leaf there is disposed a horizontally-running running rail substantially in the area of the horizontal center. A roller guide engages therein. This sliding door is configured as an externally running sliding door. An opening movement is effected by initially displacing a door leaf outward and simultaneously obliquely upward, and then displacing it along the outer wall of the vehicle. The raising of the door leaf is effected in this case, for example, at an angle of 45° obliquely upward. The drive for opening and closing the door is affected electromechanically.

All the sliding doors for motor vehicles known in the prior art have in common that the guide rails running along the displacement movement are in most cases provided in the area of an upper and a lower end section of a door, which is displaceable substantially in the horizontal direction. In addition, in automobiles in most cases, one of the guide rails is disposed visibly on the outside of the body, which is visible from outside in the closed position of the door leaf. In many cases, such sliding door systems no longer fulfill the present-day requirements of attractive appearance, design, and functionality.

Furthermore, due to the arrangement of a guide mechanism at the upper end section of the door leaf, the guide systems known in the prior art can scarcely be used for convertible or coupe modules. This is because a frame-side upper guide for a window pane that can be lowered is not provided in such motor vehicles. Due to the lack of an upper door frame, the use of conventional guide systems for sliding doors for such motor vehicles has not been considered hitherto.

In view of the foregoing, it is at least one object of the present invention to provide a guide mechanism for a sliding door of a motor vehicle, which is also universally suitable for door leaves and sliding doors with windowpanes that can be lowered, which are held in a frameless manner. In addition, the guide mechanism should be simple to assemble and maintain. The guide mechanism should also be substantially concealed or covered for the motor vehicle occupants. In addition, other objects, desirable features, and characteristics will become apparent from the subsequent summary and detailed description, and the appended claims, taken in conjunction with the accompanying drawings and this background.

### SUMMARY

The at least one object, objects, desirable features, and characteristics, forming the basis of the invention is achieved with the aid of a sliding door that comprises a door leaf and a guide rail assigned to the door leaf. This guide rail engages with a sliding element. The sliding element is connected to the supporting structure or the body of the vehicle by means of a pivotably mounted pivoted lever. The sliding element is preferably located at a free end section of the pivoted lever, which is hinged to the body or the supporting structure by means of its other end section.

Furthermore, a cover device is provided for the guide rail provided on the inner side of the sliding door leaf or disposed thereon. This cover device is configured to separate or cover the guide rail of the guide mechanism with respect to the vehicle interior. In this way, the guide rail or the entire guide mechanism can be covered or concealed in a barely visible manner for the vehicle occupants.

In addition, such a cover device has the advantage that the vehicle occupants cannot unintentionally trap fingers or items of clothing or similar objects in the guide mechanism. Otherwise, there would be a risk of injuries or damage to object or parts of the body penetrating into the guide system. The cover device also prevents the penetration of dust and dirt into the guide mechanism. This mechanism therefore contributes toward smooth, low-maintenance, and reliable operation of the entire guide mechanism.

According to a first advantageous embodiment of the invention, the cover device has a longitudinal extension corresponding to the length of the guide rail. The cover device preferably extends over the entire guide rail, or at least over the part of the guide rail, which is actively used by the sliding element as a traverse section during the opening and closing of the door leaf.

At the same time, it can be provided that the cover device has individual elastically resilient elements such as possibly brushes, which close the area of the guide mechanism which is open toward the interior of the door. The pivoted lever is guided through these brushes or a comparable comb-like arrangement of elastically resilient fingers. In this way, it can be achieved that the components required for the guide (i.e., pivoted lever and/or sliding element) enter in engagement with the relevant guide rail by penetrating or passing through the cover device.

According to a further embodiment of the invention, a cover track is provided for the cover device. This extends substantially over the entire longitudinal extension of the guide rail. The longitudinal extension of the cover track at least corresponds to the length of the traverse path of the sliding element on the guide rail between the two end positions (i.e., opening and closing position of the door leaf).

At the same time, it is provided in particular that the cover track is coupled to the sliding element or to the pivoted lever. The coupling is thereby affected in such a manner that the cover track executes a relative movement, preferably in the direction of the longitudinal extension of the guide rail, during displacement of the door leaf between open or closed position with respect to the guide rail. At the same time, it is provided in particular that the coupling between the cover track and the sliding element or the pivoted lever is configured as a fixed connection at least with regard to the displacement path of the sliding element in the guide rail. That is, the cover track is rigidly coupled to the sliding element or the pivoted lever with regard to movements along the guide rail. On the other hand, the cover track can be freely movable with respect to the sliding element and/or the pivoted lever at least within certain limits obliquely or perpendicular to the extension of the guide rail.

It is furthermore provided that the cover track can be wound onto a winding shaft at its end sections lying in the longitudinal direction of the vehicle or the end sections coming to rest in the area of the free ends of the guide rail. The winding shafts disposed at a distance from one another are spring-loaded in opposite directions so that the cover track is always held under tension by means of the springs provided on the winding shafts. The cover track can be moved almost arbitrarily with the sliding element or the pivoted lever relative to the guide rail of the guide mechanism by means of the spring-loaded winding shafts. The winding shafts for the cover track are locally fixed with respect to the guide rail of the guide mechanism. They preferably come to rest at the height of the area of the opposite end sections of the guide rail.

It is furthermore provided that the cover track is guided between the winding shafts which are spaced apart from one another parallel to the longitudinal extension of the guide rail in opposite guides. These cover track guides extend between holders or bearings for the winding shafts. The cover track guides preferably run parallel to the longitudinal extension of the guide rail and embrace the cover track laterally. For this purpose, they preferably have a U-shaped cross-sectional profile, which in each case encloses a lateral edge of the cover track.

The cover track guides open directly into the holders or into the bearings for the winding shafts. At the same time, it can be provided in particular that the cover track guides are connected in one piece to the end-side holders or bearings for the winding shafts. Whereas the cover track guides have a substantially U-shaped and relatively narrow cross-sectional profile perpendicular to the winding track plane, the holders are configured to be broadened toward the longitudinal-side end. At the front side, the winding shaft comes to abut against or between these flange-like broadened sections. The broadened sections of the holders in the area of the winding shaft mounting thus provide a guide for the cover track during winding or unwinding.

According to a further advantageous embodiment of the invention, it is provided that the cover track has an intermediate piece, through which the pivoted arm or the sliding piece passes. This intermediate piece preferably has an increased stability and strength compared with the remaining cover track. This is used for coupling the movement of sliding piece or pivoted arm to the cover track. If the sliding piece is displaced in the guide rail during opening or closing of the door leaf, this relative movement is transmitted directly to the cover track via the intermediate piece. In this respect, the intermediate piece provides an entraining function and coupling of movement of the sliding piece or pivoted arm with the cover track.

The intermediate piece is preferably integrated flush in the cover track and has a through opening adapted to the geometry of the pivoted arm or the sliding piece. This is configured in such a manner that the intermediate piece receives the pivoted arm or the sliding piece free from play.

It can furthermore be provided that the intermediate piece is connected to the cover track by adhesion, vulcanizing, and/or over molding or injection molding into the cover track. At the same time, it can furthermore be provided that the cover track is connected to the intermediate piece adjoining the intermediate piece over its entire width. However, it can also be provided that the cover track is configured to be continuous and the intermediate piece merely provides a section-wise structural reinforcement, and consequently therefore only provides a structurally reinforced through opening for the pivoted arm or the sliding piece in sections, preferably at the center between the lateral edges of the cover track.

It can furthermore be provided that the longitudinal extension of the intermediate piece parallel to the longitudinal extension of the cover track guides or the guide rail is relatively short since the intermediate piece is only suitable for winding on the winding shaft to a limited extent due to its structurally reinforced configuration. The intermediate piece is therefore positioned in every possible position of the sliding door leaf between the end-side winding shafts. In order that the distance between the two winding shafts or winding shaft holders can be kept as small as possible, it is advantageous if the longitudinal extension of the intermediate piece on each side of the pivoted arm passing there through approximately corresponds to the width of the cover track.

According to a further advantageous embodiment of the invention, it is provided that the cover track comprises a plastic film, which is particularly simple to assemble and inexpensive to manufacture. In addition, such a plastic film should be provided with a surface condition, which is adapted to the inner cladding of the surrounding door.

It is furthermore provided that at least one of the guides provided for the cover track is disposed directly on the guide rail for the sliding element. The cover track guides and the guide rail run substantially parallel to one another and at least one cover track guide disposed directly on the guide rail can in particular be connected in one piece to the guide rail or however, the cover track guide can be integrated directly in the guide rail for the sliding element.

It is feasible, for example, that the guide rail for the sliding element, which has a substantially U-shaped profile, has a further guide groove for the cover track on the front side at a profile leg which is configured to be somewhat broadened.

It is furthermore provided that the entire cover device (i.e., the cover track, the cover track guides, and/or the relevant winding shafts and holder) are disposed below an armrest of the door inner cladding. In such an embodiment, it is provided in particular that the guide rail for the guide mechanism is disposed underneath the armrest of the door inner cladding or is covered by this armrest. In this way, due to the arrangement of the guide rail and the relevant cover device underneath of an armrest, an arrangement of the guide or cover mechanism which is concealed as possible for the vehicle occupants is provided.

According to a further embodiment, a cover device is provided for the guide mechanism of a previously described sliding door. The cover device has at least one cover track which is rolled onto winding shafts disposed at a distance from one another. The cover track is held under tension by means of these spring-loaded winding shafts. In addition, a pivoted arm which engages with the guide rail of the guide mechanism passes through this cover track so that during an opening or closing movement of the door leaf, it is moved jointly according to a guidance of the pivoted arm in the guide rail and partitions, separates, and closes the remaining sections of the guide mechanism with respect to the motor vehicle interior.

### BRIEF DESCRIPTION OF THE DRAWINGS

The embodiments of the present invention will hereinafter be described in conjunction with the following drawing figures, wherein like numerals denote like elements, and

FIG. 1 shows a perspective view of the inner side of a door leaf,

FIG. 2 shows a schematic view of the guide mechanism of the door lea;

FIG. 3 shows a perspective view of the cover device with different door leaf positions;

FIG. 4 shows a cross-sectional view of the door leaf,

FIG. 5 shows an enlarged view of the upper guide mechanism and the cover device according to FIG. 4; and

FIGS. 6a to 6d show a perspective view of the door leaf and the cover device in different door opening positions.

### DETAILED DESCRIPTION

The following detailed description is merely exemplary in nature and is not intended to limit application and uses. Furthermore, there is no intention to be bound by any theory presented in the preceding summary and background or the following detailed description.

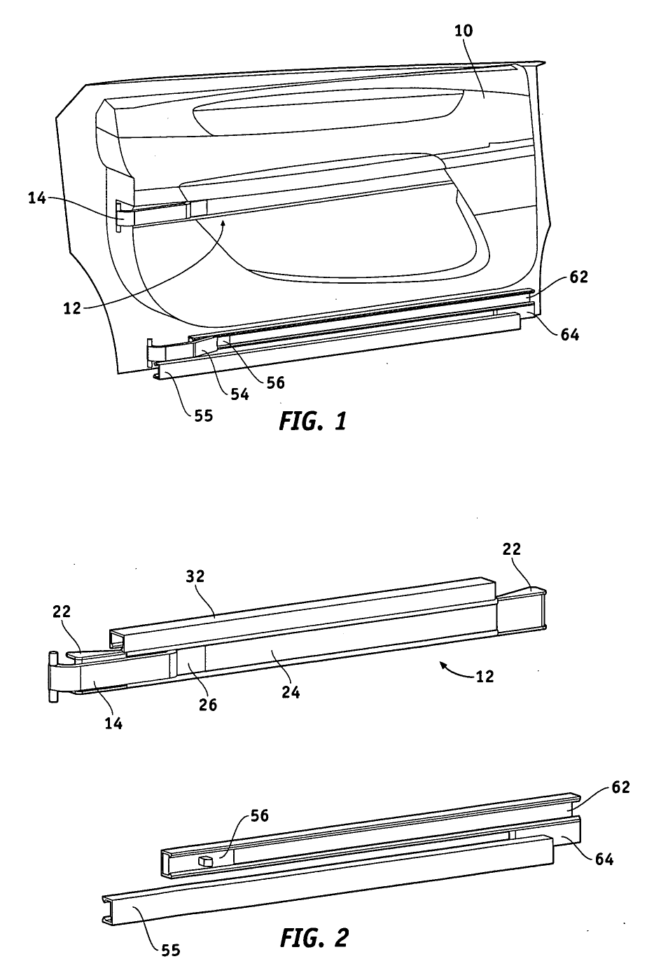

FIG. 1 shows the door leaf 10 of a sliding door of a motor vehicle in a perspective view. The door leaf 10 has two guide rails 12, 62 disposed on the door leaf side, while a further guide rail 52 is provided on the body side. Guided in the guide rails are sliding elements 18, 56, which are alternately hinged either to the motor vehicle body or to the door leaf by means of pivoted arms 14, 54, 64. The lower guide rails 62, 52 provided in the sill area and related sliding elements 56 form a parallelogram-like arrangement.

The guide rail 62 is disposed on the inner side of the door leaf 10. The relevant sliding element 56 is hinged by means of a pivoted arms 54 on the body or supporting structure side. This behaves precisely conversely to the other guide rail 52 disposed in the sill area. A sliding element, not shown explicitly in the figures, is displaceably disposed in said guide rail, which is coupled to the door leaf 10 via a pivoted arm 64.

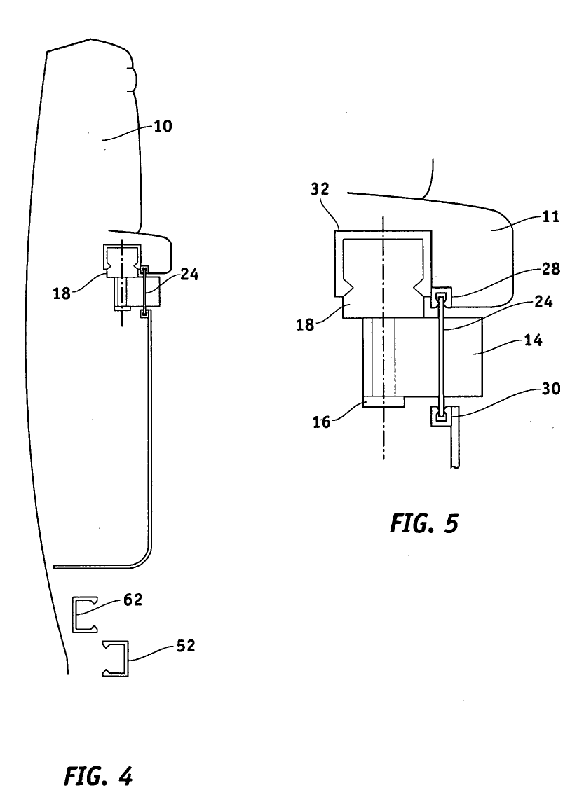

Furthermore, another guide rail 32 is provided in the waistline area of the door leaf on the inner side of the door leaf, in which, as shown in FIG. 4, a sliding element 18 is displaceably guided. This sliding element, not shown explicitly in FIG. 1, is connected to the motor vehicle body or to the supporting structure of the motor vehicle by means of a pivoted lever 14.

On opening the door leaf or the sliding door, this is pivoted into an exposed position with respect to the motor vehicle body through a pivoting movement of the three pivoted arms 14, 54, 64 in total, from which the sliding elements 18, 56 can be displaced into the relevant guide rails 32, 62, 52.

Since the guide rails 32, 52, 62 or functional parts of the guide mechanism of the door leaf are disposed underneath a window opening of the sliding door and the upper guide rail 32 is integrated directly in the inner cladding of the door leaf 10, a cover device 12 is provided for this upper guide unit.

The cover device 12 extends substantially over the entire length of the upper guide rail 32, as is deduced in particular from FIG. 2. This comprises two upper and lower guide profiles 28, 30 running substantially parallel to one another and parallel to the guide rail 32, in which a cover track 24 or a cover roller blind is displaceably guided. The cover track 24 is rolled on respectively one spring-loaded winding shaft 34, 36 at the longitudinal-side ends of the cover device 12. The spring-loaded winding shafts have the effect that the resilient and deformable cover track 24 is held continuously under tension and that the cover track together with the pivoted lever 14 or the sliding element 18 mounted in the guide rail 32 can be jointly moved with respect to the guide rail 32.

To this end, an intermediate piece 26 is provided in particular on the cover track 24, said intermediate piece comprising reinforced or structurally stiffened material compared with the cover track 24. This intermediate piece 26 further has a through opening for the pivoted lever 14, which is connected in this way, by passing through the cover track 24, to a sliding element 18 located on the other side of the cover track 24 by means of a bearing bolt 16.

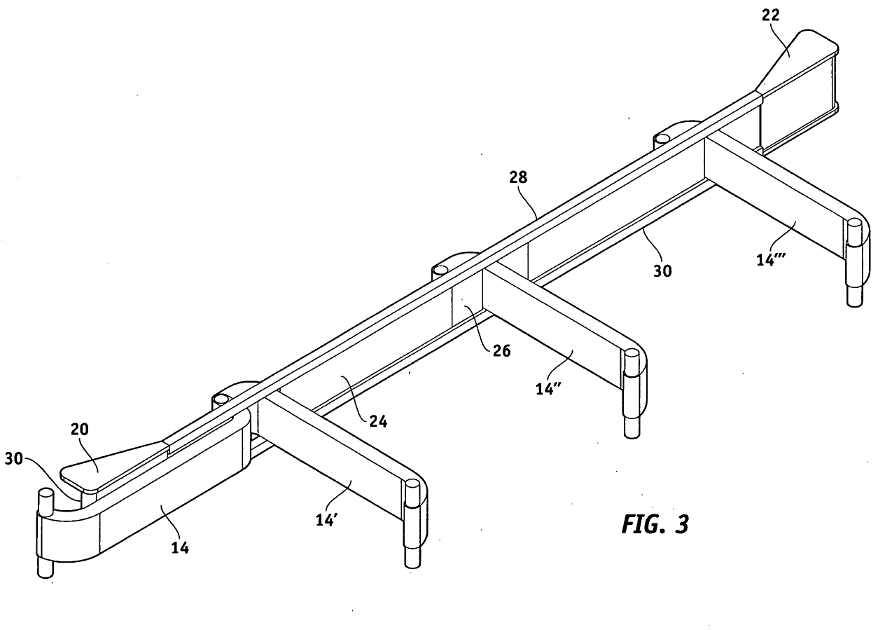

FIG. 3 shows a total of four different positions of the pivoted lever 14, 14′, 14″, 14′″, which successively indicate the individual positions of the pivoted lever 14 on opening the sliding door.

The winding shafts 34, 36 are mounted in holders 20, 22. These holders which are configured to be broadened toward the free end section of the cover device form a lateral guide for the cover track 24 to be wound.

FIG. 5 further shows the integration of the guide rail 32 in the armrest 11 of a door inner cladding. The relevant cover device 12 with its covering roller blind directly adjoins the lower end section of the armrest 11 so that this area remains substantially unnoticed and poorly visible for the vehicle occupants.

It can be additionally be identified in FIG. 5 that the cover track 24 is in each case embraced by a relevant cover track guide 28, 30 at its upper and edge-side sections. In this case, the upper cover track guide 28 in FIG. 5 is directly connected to the guide rail 32. Alternatively, it can be integrated directly in the guide rail 32.

It is also feasible to configure the guide rail 32 as an upwardly open guide rail, which then accordingly comes into abutment with the lower cover track guide 30. It is further within the scope of the invention that the guide rail 32 is disposed similarly to the guide rail 62 so that it is open toward the side and that the cover device 12, but in particular the cover track 24, is aligned accordingly so that it is turned through 90o so that the pivoted lever 14 passes through the cover device 12 not horizontally but vertically.

It is furthermore feasible that in the configuration according to FIG. 5, the cover device 12, but in particular the covering roller blind 23, is aligned not vertically but substantially horizontally and is penetrated by the bearing bolt 16 instead of by the pivoted lever 14.

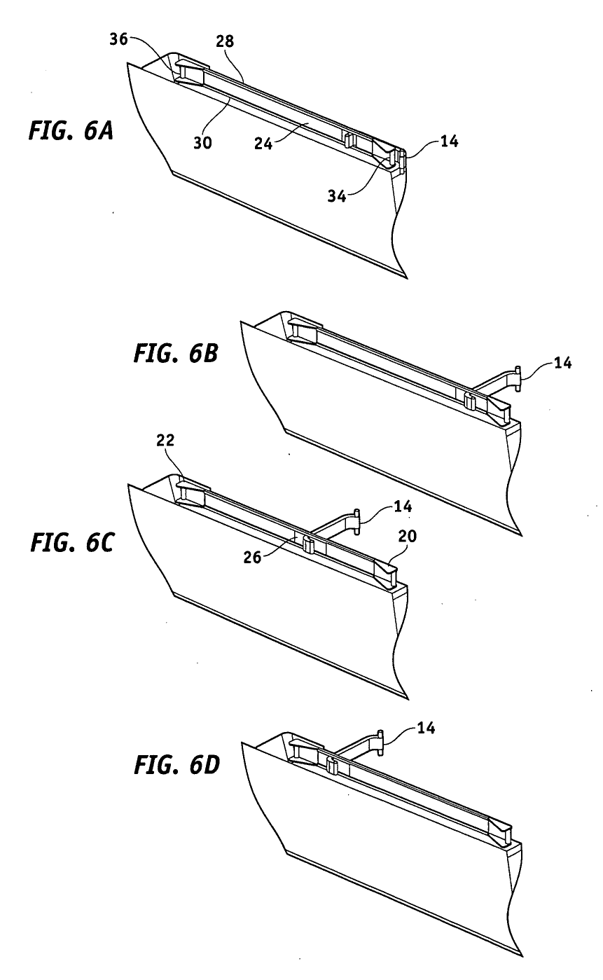

FIG. 6a to FIG. 6d further show successively the individual positions of the intermediate piece 26 and the pivoted lever 14 during an opening process of the door leaf. In this case, the positions shown in FIG. 6a to FIG. 6d substantially correspond to the positions of the pivoted lever 14, 14′, 14″, and 14′″ reproduced in FIG. 3.

In FIG. 6a the door is located in its closed position. The pivoted lever 14 extends substantially parallel to the cover device 12. As soon as the opening movement is initiated, the entire door leaf is transferred into the position shown in FIG. 6b by means of the pivoted arms 14, 54, 64. The door leaf is then shifted further to the right so that the pivoted lever 14 and the sliding element 18 hinged thereto migrates further to the left in the guide rail 32 until the door has reached its end stop or opening position in FIG. 6d.

In FIG. 6a to FIG. 6d, the door leaf which is displaceable with respect to the motor vehicle body is selected as a reference system. In this respect, the pivoted lever 14 moves with respect to the supposedly fixed door leaf. In practice, however, this is reversed. The pivoted lever 14 is fastened in a fixed position on the vehicle body with its articulation point facing away from the door leaf so that, starting from the diagram in FIG. 6a as far as the diagram in FIG. 6d, the door leaf 10 is successively transferred to the right into its open position.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing detailed summary and description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A sliding door of a motor vehicle, comprising:
a sliding door leaf having an inner side;
a guide rail assigned to the inner side of the sliding door leaf that engages with a sliding element, which is connected to a supporting structure of the motor vehicle with a pivotably mounted pivoted lever; and
a cover device that substantially separates the guide rail with respect to an interior of the motor vehicle in at least a closed position of the sliding door leaf.

2. The sliding door according to claim 1, wherein the cover device has a longitudinal extension corresponding to a length of the guide rail.

3. The sliding door according to claim 2, wherein the cover device has a cover track that substantially extends over the longitudinal extension of the guide rail.

4. The sliding door according to claim 3, wherein the cover track is coupled to at least one of the sliding element or a pivoted lever.

5. The sliding door according to claim 3, wherein the cover track executes a relative movement during a displacement of the sliding door leaf into at least one of an open position or the closed position relative to the guide rail.

6. The sliding door according to claim 3, wherein the cover track can be wound onto a winding shaft at end sections lying in a longitudinal direction of the motor vehicle.

7. The sliding door according to claim 3, wherein the cover track is guided between winding shafts in a first guide and second guide opposite to the first guide which extend between holders for the winding shafts.

8. The sliding door according to claim 3, wherein the cover track has an intermediate piece through which passes at least one of a pivoted arm or a sliding piece.

9. The sliding door according to claim 8, wherein the intermediate piece is integrated in a flush manner in the cover track and has a through opening adapted to a geometry of at least one of the pivoted arm or the sliding piece.

10. The sliding door according to claim 8, wherein the intermediate piece is connected to the cover track by adhesion.

11. The sliding door according to claim 8, wherein the intermediate piece is connected to the cover track by vulcanizing.

12. The sliding door according to claim 8, wherein the intermediate piece is connected to the cover track by over-molding.

13. The sliding door according to claim 8, wherein the intermediate piece is connected to the cover track by injection molding.

14. The sliding door according to claims 3, wherein the cover track comprises a plastic film having at least one of an outer contour or surface condition adapted to the inner cladding.

15. The sliding door according to claim 3, wherein at least one guide is provided for the cover track is disposed directly on the guide rail.

16. A cover device for guide parts of a sliding door, comprising:
a winding shaft; and
a cover track rolled onto the winding shaft and disposed at a distance from winding shafts through which track passes a pivoted arm engaging with a guide rail.
